(19) United States
(12) Patent Application Publication
(10) Pub. No.: US 2020/0184380 A1
(43) Pub. Date: Jun. 11, 2020

(54) CREATING OPTIMIZED MACHINE-LEARNING MODELS

(71) Applicant: International Business Machines Corporation, Armonk, NY (US)

(72) Inventors: Gegi Thomas, Yorktown Heights, NY (US); Adelmo Cristiano Innocenza Malossi, RUESCHLIKON (CH); Tejaswini Pedapati, Yorktown Heights, NY (US); Ganesh Venkataraman, Yorktown Heights, NY (US); Roxana Istrate, Yorktown Heights, NY (US); Martin Wistuba, DUBLIN (IE); Florian Michael Scheidegger, RUESCHLIKON (CH); Chao Xue, BEIJING (CN); Rong Yan, BEIJING (CN); Horst Cornelius Samulowitz, YORKTOWN HEIGHTS, NY (US); Benjamin Herta, Yorktown Heights, NY (US); Debashish Saha, Yorktown Heights, NY (US); Hendrik Strobelt, Yorktown Heights, NY (US)

(21) Appl. No.: 16/216,138

(22) Filed: Dec. 11, 2018

(51) Int. Cl. G06N 20/20; G06N 3/08; G06N 3/04

(52) U.S. Cl. CPC G06N 20/20; G06N 3/0454; G06N 3/082

(57) ABSTRACT

A machine-learning model generation method, system, and computer program product deciding, via a first algorithm, a machine-learning algorithm that is best for customer data, invoking the machine-learning algorithm to train a neural network model with the customer data, analyzing the neural network model produced by the training for an accuracy, and improving the accuracy by iteratively repeating the training of the neural network model until a customer-defined constraint is met, as determined by the first algorithm.

### BACKGROUND

The present invention relates generally to a machine-learning model generation method, and more particularly; but not by way of limitation, to a system, method, and recording medium for automatically generating optimal Machine-learning (ML) models using customer-provided datasets and customer-provided inputs of requirements.

Different conventional techniques exist to create machine-learning (ML) models and neural network (NN) models. The basic prerequisites across existing approaches include having a dataset, as well as basic knowledge of ML model synthesis, NN architecture synthesis and coding skills.

Conventionally, for obtaining models with higher refined accuracies, even further specialized knowledge is needed to hand-tune a network for optimal accuracy. In new domains (e.g., enterprise environments), there is an abundance of data, but minimal access to ML expertise. This results in a high barrier to successfully leveraging Artificial Intelligence (AI)/NN architectures as a new class of solutions to enterprise problems.

Conventionally, companies have used transfer learning with their data, but this may not be an appropriate approach in the enterprise, as data is highly protected.

Conventional techniques that tackle the automation of MUDS only support subsets of the data science workflow, and are mainly restricted in that only hyper-parameter optimization (e.g., tuning of model parameters)is allowed, only workflows of very limited depth are enabled, there is no consideration of stakeholder constraints (e.g., budget and requirements), there is no life-long learning mechanism, there is no automated client-specific personalized learning mechanisms, and there is no leveraging of client/task domain knowledge.

Thus, there is a need in the art for a technique to allow companies to process their data with highly trained ML/NN analysis without having to hire employees with ML/NN training.

### SUMMARY

In an exemplary embodiment, the present invention p vide a machine-learning model generation computer-implemented method, the machine-learning model generation method including deciding, via a first algorithm, a machine-learning algorithm that is best for customer data, invoking the machine-learning algorithm to train a neural network model with the customer data, analyzing the neural network model produced by the training for an accuracy, and improving the accuracy by iteratively repeating the training of the neural network model until a customer-defined constraint is met, as determined by the first algorithm.

One or more other exemplary embodiments include a computer program product and a system.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which

FIG. 1 exemplarily shows a high-level flow chart for a machine-learning model generation method 100;

FIG. 2 exemplarily depicts an overview of the method 100 according to an embodiment of the present invention;

FIG. 3 exemplarily depicts a system overview of the method 100 according to an embodiment of the present invention;

FIG. 4 depicts a cloud computing node 10 according to an embodiment of the present invention;

FIG. 5 depicts a cloud computing environment 50 according to an embodiment of the present invention; and

FIG. 6 depicts abstraction model layers according to an embodiment of the present invention.

### DETAILED DESCRIPTION

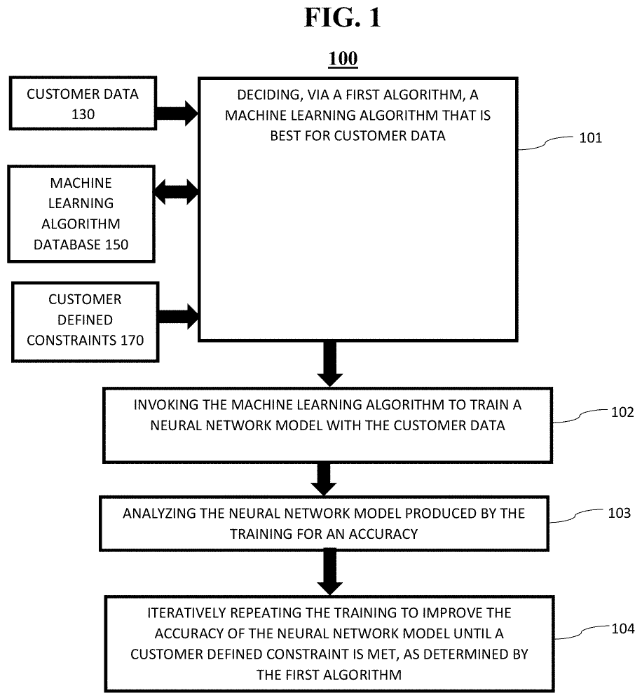

The invention will now be described with reference to FIG. 1-6, in which like reference numerals refer to like parts throughout. It is emphasized that, according to common practice, the various features of the drawing are not necessarily to scale. On the contrary, the dimensions of the various features can be arbitrarily expanded or reduced for clarity.

With reference now to the example depicted in FIG. 1, the machine-leaning model generation method 100 includes various steps for automatically choosing an optimal algorithm (or algorithms) to optimally solve the assigned machine-learning task.

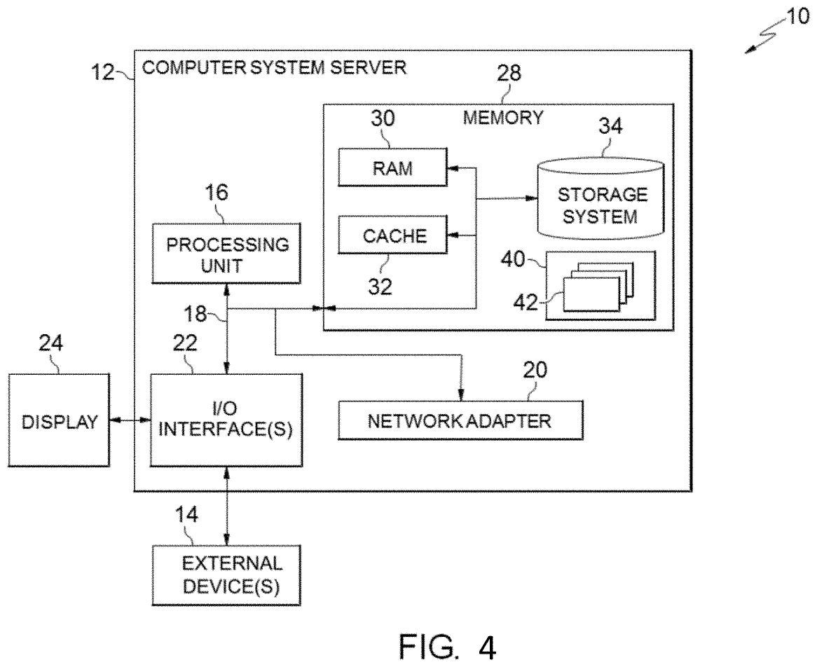

As shown in at least FIG. 4, one or more computers of a computer system 12 according to an embodiment of the present invention can include a memory 28 having instructions stored in a storage system to perform the steps of FIG. 1.

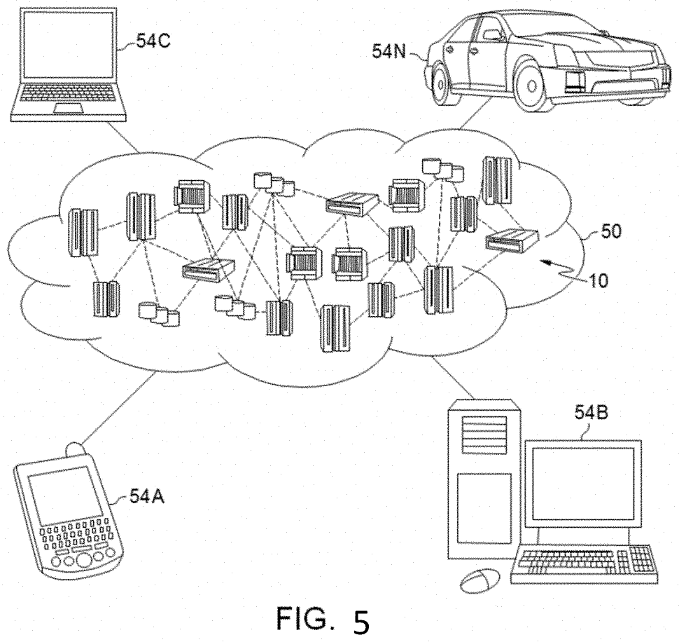

Although one or more embodiments (see e.g., FIGS. 4-6) may be implemented in a cloud environment 50 (see e.g., FIG. 5), it is nonetheless understood that the present invention can be implemented outside of the cloud environment.

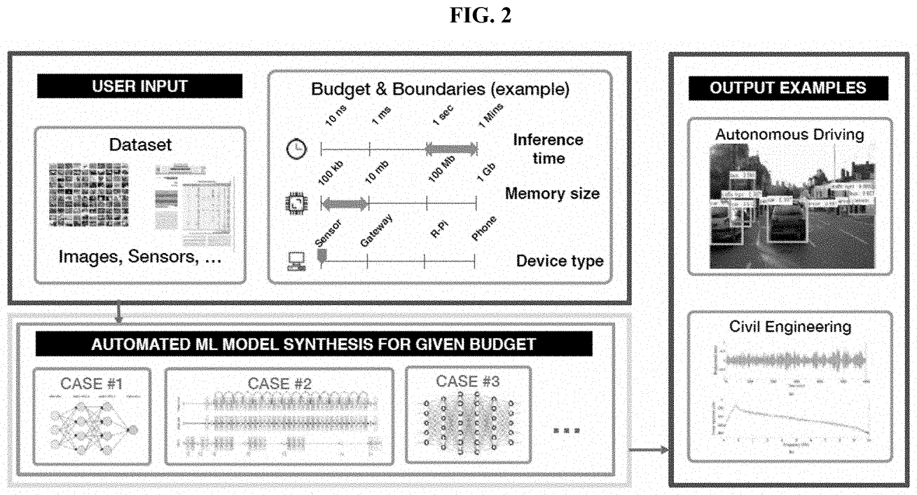

With reference generally to FIG. 1, the method 1.00 receives inputs of customer data 130 including their dataset which can be raw data, sensor data, images, etc. (e.g., as depicted in FIG. 2). The method 100 also receives an input of a customer-defined constraint 170. The constraints, for example, may include a budget and boundaries of a customer such as inference time, memory size, device type, cost, etc. (e.g., as depicted in FIG. 2). That is, the customer-defined constraints 170 may essentially include how much the customer is willing to spend to refine the neural network model to process their data and provide results.

In step 101, a machine-learning (ML) algorithm is decided, via a first algorithm, that is best for the customer data 130.

The first algorithm is based on the budget and boundaries provided by the user plus (optionally) a characterization of the dataset in term of difficulty, size, plus (optionally) hardware information about resources to use and where to deploy the final model. For example: if the user specifies a stringent time to develop the model, the invention does not use ML algorithms that are known to be slow. If the user asks for TOP accuracy, the invention drops algorithms that are based on prediction and approximation. More generally, every ML algorithm is characterized by pros/cores, and associated with a range of budget & boundaries input from the user, data complexity, and target hardware info.

That is, the first algorithm decides which ML algorithm from the machine-learning algorithm database 150 that can optimally solve the assigned ML task. The first algorithm includes steps that automatically choose the optimal ML algorithm (or algorithms) to optimally, solve the assigned ML task. This choice is uniquely made on the customer-provided data and budget/requirements. No other input is asked to/from the customer.

The first algorithm enables the invention to automatically generate optimal Machine-learning (ML) models, exclusively from data and a limited set of customer input(s), namely budget and requirements with no programming experience or other ML knowledge being required.

The ML algorithm database (or in the alternative a term that could be used would be a ‘registry’, or ‘repository’). 150 allows the invention to plug-in one or many algorithm(s) as needed. Each algorithm can be designed to satisfy a different set of type of data and budget and boundary (e.g., memory size, etc.) requirements. In other words, the database 150 can continuously be expanded to include any new state of the art ML algorithms newly designed. Thereby, the invention is continuously operating at a state of the art level. The ML algorithms uniquely generate, manipulate, or select NN models to be served to the user as-is or partially or completely retrained, given any previously created NN model. As such, the invention is very dynamic to changes in technology.

In step 102, the selected ML algorithm is invoked to train a neural network model with the customer data 130. To do so, part of the customer data 130 is set aside to measure an accuracy of the model (as described later) and the neural network model is trained with the ML algorithm on the rest of the customer data 130 not set aside. Thus, step 102 can invoke one or more implementations of the ML algorithms in a stateless manner to generate one or more ML models. For purposes of the invention, “stateless” may he defined as having no memory recollection from a previous operation. As such, the invention need not store artifacts of previous operations. Stateless means the absence of stored information; in our case, each ML algorithm does not internally store or collect any information. It bases all of it's calculations on the information directly provided to it, and does not retain any information that it is provided.

In step 103, the neural network model produced by the training is analyzed for an accuracy. The accuracy measures a difference between an actual result and a result from the neural network model on the customer data 130. That is, the accuracy is analyzed using the set aside data set of the customer data 130.

In step 104, the training is iteratively repeated to improve the accuracy of the neural network model until a customer-defined constraint 170 is met, as determined by the first algorithm. For example, the NN model is improved by pre-processing data, predicting performance of models, training models, generating models, loading and manipulating models, combining models, evaluating performance of models, etc. until the budget of the customer is met (i.e., within the customer-defined constraints 170). The end result of the inventive method is an optimized odd

It is noted that in step 104, the ‘repeating’ can just partially re-train, or change the pre-processing and re-train a few epochs, or apply transfer-learning and almost not re-train, or reuse a model that are stored in the past and not train at all. The repeating more generally means that the invention is more an optimization cycle to further fine tune the model. In other words, the invention includes iteratively invoking machine-learning algorithms to adapt and re-train the neural network model until a customer-defined.

In other words, the NN model is continuously improved and refined to provide a better solution set for the customer data until the budget of the customer is exhausted. For example, if the budget allows for 50 iterations, the NN model will be retrained 50 times to increase the accuracy. If the budget allows for 10000 iterations, the model will be retrained 10000 times to increase the accuracy and so on. The numbers of iterations is constrained by the customer-defined constrained 170 and are confirmed in the first algorithm (e.g., the first algorithm determines how many times the NN model can be re-trained to increase the accuracy).

The data provided by the customer is validated and converted to a requested format and size. Contingent on passing validation checks, the method 100 leverages an internal state-machine configuration to drive the iterative execution of the system to a completion state, while storing all relevant generated execution artifacts to a database service for persistence.

The data is analyzed and characterized by features, property and difficulty. Automated preprocessing can be applied to data to improve the final model in the iterative re-training. That is, in step 104, the method iteratively invokes algorithms for NN models to train the models, generate the models, load and manipulate the models, combine the models, etc. to improve the accuracy. The method 100 proceeds to facilitate training of the models, provides results to algorithms for reflective evaluation, again then again invokes algorithms for ML algorithms to train.

Therefore, not only does the first algorithm select the optimal ML algorithm to process the customer data 130, the first algorithm also controls how many iterations are performed to refine the produced NN model within the customer-defined constraints 170.

The method 100 stops repeating the training (e.g., successfully completes) when the predetermined constraints has been exhausted, and the optimal model is selected (based on highest accuracy) and copied to end customer's specified cloud object store bucket (i.e., end customer's specified final model destination).

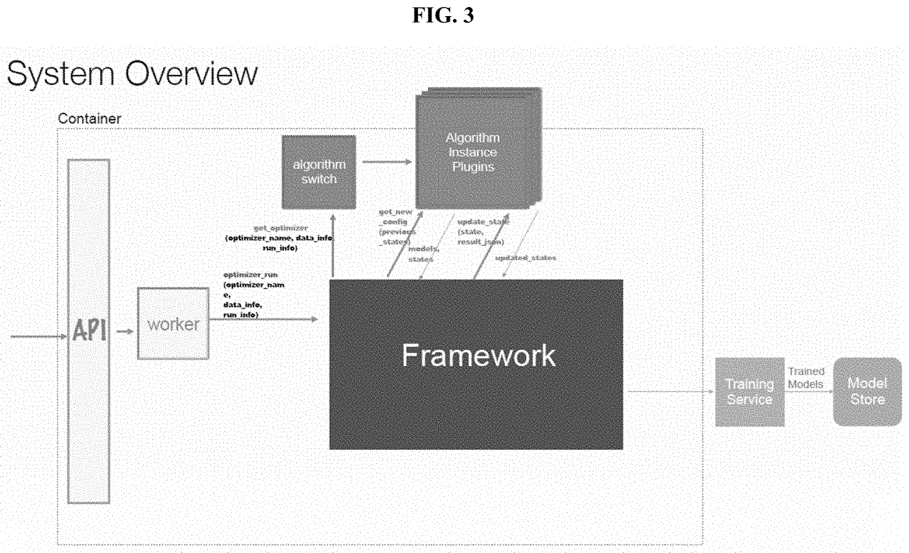

FIG. 3 exemplarily depicts a system architecture for the method 100. The system is implemented via a set of ML algorithms that are iteratively invoked via a stateless, predefined interface. The system packages these algorithms in a “plug-in” model, where they can be dynamically edited/added/deleted. The algorithms themselves uniquely generate, manipulate, or select NN models to be served to the customer as is or partially or completely retrained. The algorithms invocation is coordinated by a system runtime framework. The customer of the system initiates the overall ‘optimization’ job by invoking clearly defined REST APIs with relevant JSON-formatted payload data. Those REST API can be hidden behind a clean and simple user-interface (UI) (e.g., as shown in FIG. 2).

Thus, the invention includes a technique of automating a machine-learning process for generating optimal NN models based on customer-provided data within a client server environment according user-provided instructions by analyzing the dataset to identify a best suited ML algorithm among many (e.g., from a database of ML algorithms). The method includes automating a machine-learning process based on receiving a customer dataset for analyzing and choosing the most optimum ML algorithm for the data by running few sample algorithms on the dataset to observe and analyze the test results for predicting the next best suited algorithm for the dataset.

In one embodiment, the first algorithm is designed to select a different ML algorithm to satisfy a different set of type of data and budget and boundary requirements and automatically managing tasks for pre-processing data, predicting performance of models, training models, generating models, loading and manipulating models, combining models and evaluating performance of models.

That is, at a high level, the invention includes generating optimal Machine Learning (ML) models, exclusively from data and a limited set of user input, automatically choosing and optimal algorithm (or algorithms) to optimally solve the assigned ML task, invoking one or more implementation of the algorithms in a stateless manner to generate one or more ML model, and automatically managing and executing tasks.

In another embodiment, the customer of the system initiates the overall process by invoking clearly defined REST APIs with relevant JSON-formatted payload data. (APIs can be concealed behind a UI). The customer data is analyzed and characterized by features, property and difficulty. Automated preprocessing can be applied to data to improve the final model. The data provided by the customer is validated and converted to a requested format and size. The system can analyze the customer submitted data and determine which algorithm is best suited for execution, given the time/money constraints by an end customer. Alternatively, the system can be directed to a specific algorithm for use. The system leverages an internal state-machine configuration to drive the iterative execution of ML algorithms from a beginning state to a completion state. The system iteratively invokes algorithms for ML models to train models, generate models, load and manipulate models, combine models, etc. The system proceeds to facilitate training of models, provides results to algorithms for reflective evaluation, then again invokes algorithms for ML models to train. All relevant generated execution artifacts are persisted during execution. The system completes successfully when predetermined user budget has been exhausted, and the optimal model is selected (based on highest accuracy) and provided to the end customer.

Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings,

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 4, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 4, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g,, the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 5, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community; Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 5 are intended to be illustrative only and that computing nodes 10 and cloud computing environment 50 can communicate with any type of computerized circuit over any type of network and/or network addressable connection (e.g., using a web browser),

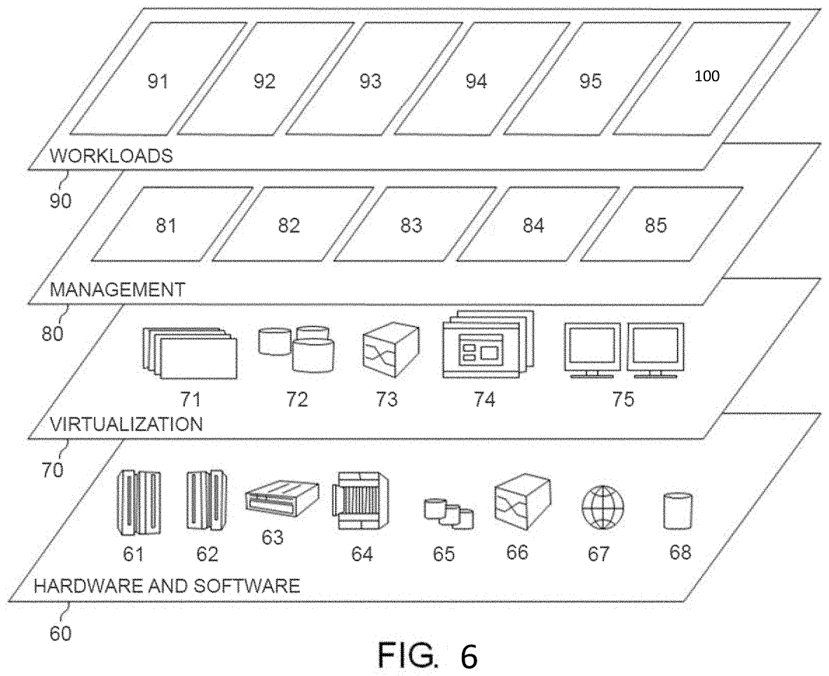

Referring now to FIG. 6, an exemplary set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the method 100.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic: cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing'processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the us computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A machine-learning model generation computer-implemented method, the machine-learning model generation method comprising:
deciding, via a first algorithm, a machine-learning algorithm that is best for customer data;
invoking the machine-learning algorithm to train a neural network model with the customer data;
analyzing the neural network model produced by the training for an accuracy; and.
improving the accuracy by iteratively repeating the training of the neural network model until a customer-defined constraint is met, as determined by the first algorithm.

2. The machine-learning model generation computer-implemented method of claim 1, wherein the machine-learning algorithm is selected from a database including a plurality of machine-learning algorithms.

3. The machine-learning model generation computer-implemented method of claim 1, wherein the database including the plurality of machine-learning algorithms is updatable,

4. The machine-learning model generation computer-implemented method of claim 1, wherein the first algorithm decides the machine-learning algorithm based on a type of the customer data.

5. The machine-learning model generation computer-implemented method of claim 1, wherein the first algorithm decides the machine-learning algorithm based on a budget of a customer owning the customer data.

6. The machine-learning model generation computer-implemented method of claim 1, wherein the invoking trains the neural network model with the machine-learning algorithm on a first portion of the customer data, and
wherein the analyzing analyzes the accuracy based on a second portion of the customer data distinct from the first portion of the customer data.

7. The machine-learning model generation computer-implemented method of claim 6, wherein the second portion of the customer data includes a smaller size of data than the first portion of the customer data.

8. The machine-learning model generation computer-implemented method of claim 1, wherein the machine-learning algorithm is invoked in a stateless manner to train the neural network model.

9. The machine-learning model generation computer-implemented method of claim 1, wherein a plurality of machine-learning algorithms are stored in a plug-in model where each machine-learning algorithm can be dynamically edited, added, and/or deleted.

10. The machine-learning model generation computer-implemented method of claim 2, wherein the selected machine-learning algorithm comprises a combination of the plurality of Machine-learning algorithms in the database.

11. The machine-learning model generation computer-implemented method of claim 9, wherein the selected machine-learning algorithm comprises a combination of the plurality of machine-learning algorithms in the plug-in model.

12. The machine-learning model generation computer-implemented method of claim 1, wherein only the customer data and the customer-defined constraint are required as an input by a customer.

13. The machine-learning model generation computer-implemented method of claim 1, embodied in a cloud-computing environment.

14. A machine-learning model generation computer program product, the computer program product comprising a computer-readable storage medium having program instructions embodied therewith, the program instructions executable by a computer to cause the computer to perform:
deciding, via a first algorithm, a machine-learning algorithm that is best for customer data;
invoking the machine-learning algorithm to train a neural network model with the customer data;
analyzing the neural network model produced by the training for an accuracy; and
improving the accuracy by iteratively repeating the training of the neural network model until a customer-defined constraint is met, as determined by the first algorithm.

15. The machine-learning model generation computer program product of claim 14, wherein the machine-learning algorithm is selected from a database including a plurality of machine-learning algorithms.

16. The machine-learning model generation computer program product of claim 14, wherein the database including the plurality of machine-learning algorithms is updatable.

17. The machine-learning model generation computer program product of claim 14, wherein the first algorithm decides the machine-learning algorithm based on a type of the customer data.

18. The machine-learning model generation computer program product of claim 14, wherein the first algorithm decides the machine-learning algorithm based on a budget of a customer owning the customer data.

19. The machine-learning model generation computer program product of claim 14, wherein the invoking trains the neural network model with the machine-learning algorithm on a first portion of the customer data, and
wherein the analyzing analyzes the accuracy based on a second portion of the customer data distinct from the first portion of the customer data.

20. The machine-learning model generation computer program product of claim 19, wherein the second portion of the customer data includes a smaller size of data than the first portion of the customer data.

21. The machine-learning model generation computer program product of claim 19, wherein the machine-learning algorithm is invoked in a stateless manner to train the neural network model.

22. A machine-learning model generation system, said system comprising:
a processor; and
a memory, the memory storing instructions to cause the processor to perform:
deciding, via a first algorithm, a machine-learning algorithm that is best for customer data;
invoking the machine-learning algorithm to train a neural network model with the customer data;
analyzing the neural network model produced by the training for an accuracy; and
improving the accuracy by iteratively repeating the training of the neural network model until a customer-defined constraint is met, as determined by the first algorithm.

23. A machine-learning model generation computer-implemented method, the machine-learning model generation method comprising:
deciding, via a first algorithm, a machine-learning algorithm that is best for customer data based on a customer-defined constraint.

24. A machine-learning model generation computer-implemented method, the machine-learning model generation method comprising:
storing a plurality of machine-learning algorithm in a plug-in model that is updatable with new machine-learning algorithms.

25. The machine-learning model generation computer-implemented method of claim 24, further comprising
deciding, via a first algorithm, a machine-learning algorithm from the model that is best for customer data; and
improving an accuracy of a neural network trained by the machine-learning algorithm by iteratively repeating the training of the neural network model until a customer-defined constraint is met, as determined by the first algorithm.
